(19) United States
(12) Patent Application Publication
(10) Pub. No.: US 2008/0305701 A1
(43) Pub. Date: Dec. 11, 2008

(54) Textile Complex Intended to be Used as Reinforcing Layer for the Manufacture of Composite Parts, and Process for Manufacturing Such a Complex

(75) Inventors: Delphine Guigner, Mariac (FR); Sebastien Boutier, Guilherand-Granges (FR)

Correspondence Address: CANTOR COLBURN, LLP, 20 Church Street, 22nd Floor, Hartford, CT, 06103, US

(73) Assignee: CHOMARAT COMPOSITES, Paris (FR)

(21) Appl. No.: 12/097,605

(22) PCT Filed: Dec. 7, 2006
(86) PCT No.: PCT/FR2006/051308

§ 371 Date: Jun. 16, 2008

(30) Foreign Application Priority Data
Dec. 15, 2005 (FR) 0553886

(51) Int. Cl. B32B 27/12; B32B 27/04; B29C 35/02

(52) U.S. Cl. 442/63; 264/405

(57) ABSTRACT

The invention relates to a textile complex (1) intended to be used as reinforcing layer for the manufacture of three-dimensional composite parts by resin injection or infusion processes, comprising at least one fibre-based reinforcing layer (2).

It is characterized in that it comprises on one of its faces, a fixing layer (3) based on a thermoplastic having an almost zero cold elongation and a melting point below the melting point of the other materials of the complex, and in that the said fixing layer (3) is apertured to allow the passage of the injected or infused resin.

The invention also relates to a method for manufacturing a flexible preform, during which the shape of the reinforcement is maintained by the presence of a fixing layer joined to the reinforcement in a preformed mould.

### TECHNICAL FIELD

The invention relates to the field of the manufacture of composite parts, by resin injection or infusion moulding processes.

The invention relates more precisely to the textile complexes used for the manufacture of these composite parts, and more specifically a complex suitable for producing three-dimensional parts requiring the use of a preformed reinforcement.

It is a particular object of the invention to facilitate the operations associated with the manufacture of these preforms, particularly to facilitate their transport and storage, and to limit the handling operations during the manufacture of the composite part.

### PRIOR ART

In general, the manufacture of composite parts by moulding processes, whether by injection or infusion, requires the placement of a reinforcing textile structure which is then impregnated with a resin. After this resin is cured, the reinforcement imparts a certain stiffness and strength to the composite part. In the case of three-dimensional parts having complex shapes, a number of operations are necessary to ensure that the textile reinforcing layers perfectly match the outer shape of the part to be manufactured. It is in fact important, for reasons of mechanical performance, for the reinforcing layer to be as close as possible to the future outer face of the composite part.

Thus, one widely used technique for placing the reinforcement consists in cutting out a textile complex in the shape of the three-dimensional part and then manually placing the cutout complex in the injection mould. It is clear that this technique is more suitable for almost flat parts than for three-dimensional parts. This is because the textile complex is obviously manufactured in the flat state, and it is necessary to perform cutouts, folds, and other draping operations to ensure that the reinforcement matches the shape of the part to be manufactured, with the minimum possible stretching. In the case of complex shapes, this technique may prove to be problematic, insofar as the pieces of cutout reinforcement have a natural tendency to sag.

Another known technique consists in spraying reinforcing fibres and a binder of these fibres directly into the injection mould, of which typical examples are processes having the trade name “P4” and “RimFire”. The reinforcement thus being produced directly in the mould, it is clear that it has the exact shape desired. However, the production of the reinforcement of these conditions, directly in the injection mould, does not guarantee an homogeneous, uniform thickness of the reinforcement, insofar as, before fixation of the binder, the fibres will naturally tend to move under the effect of gravity. Nor is the addition of a large quantity of binder more satisfactorily insofar as this binder may then hinder the drainage and flow of the resin, and above all, degrade the surface appearance of the composite part.

This is why it has already been proposed to use preformed reinforcements, that is almost having the final shape of the mould. Such reinforcements are thus produced by weaving and stitching operations to the shape of the desired part. It is clear that this type of operation is relatively long and must be repeated according to a pattern defined for each mould. This technique is therefore difficult to apply on an industrial scale, at least at reduced production cost.

Other types of preforms are produced from reinforcements combined with a binder which gives them a certain stiffness. Such reinforcements have the advantage of being producible independently of the manufacture of the injected part. However, the production of preforms, in particular rigid preforms, has drawbacks in terms of size, particularly for storage and transport. Furthermore and above all, these reinforcements are produced by hot pressing, which does not allow the exact production of the geometry of the final part, and requires costly moulds and presses.

It is therefore an object of the invention to produce preformed reinforcements offering great ease of transport, while being easy to produce, that is without requiring large scale investment. A further object of the invention is to produce reinforcements which impart optimal mechanical properties to the parts on which they are mounted, that is which have a weight and uniformity of thickness adapted to the composite parts that they reinforce, without any deterioration in the final mechanical performance by the preforming operation.

### SUMMARY OF THE INVENTION

The invention therefore relates to a textile complex intended to be used as reinforcing layer for the manufacture of three-dimensional composite parts, by resin injection or infusion processes. Conventionally, such a complex therefore includes a reinforcing layer based on reinforcing fibres, which may be highly varied, particularly based on glass, carbon, aramide or other synthetic fibres.

According to the invention, this complex is characterized in that it comprises, on one of its faces, a thermoplastic-based fixing layer, which has an almost zero cold elongation. This material has a melting point which is lower than the melting point of the other materials of the complex, so as to melt at least partially, before the materials of the textile layer are degraded. Complementarily, the said fixing layer is apertured to allow the passage of the injected or infused resin during the manufacture of the composite part.

In other words, the complex according to the invention comprises a layer which is combined loosely with the textile reinforcing layer. This layer may be joined to the textile layer when the complex is placed in a preformed mould, and then heated sufficiently so that the said fixing layer softens and adheres to the reinforcement. After cooling, this fixing layer is joined at a large number of points to the textile reinforcing layer, so that at the fold zones, for example, this fixing layer maintains a sort of surface tension in the textile reinforcement.

The fact that the thermoplastic is not cold-extensible serves to impose a dimensional stability of the complex when the fixing layer is cooled. The non-extensible character, or the almost zero elongation, applies under normal stresses observed in the manufacture of preformed reinforcements.

The complex can thus be deformed, and particularly folded for its transport, and then recover its original shape when unfolded. In other words, this type of complex serves to obtain flexible or predraped preformed reinforcements, which can therefore be handled and folded without necessarily losing the geometry which had been imparted to them initially. The preformed reinforcement thus has a sort of shape memory which enables it to undergo easy handling and particularly a very compact size for its transport and storage.

It is clear that the addition of this fixing layer can be advantageous for many types of reinforcement, insofar as the fixing layer has a capacity to adhere to the textile layer, and a compatibility with the resin to be employed in the manufacture of the composite parts.

Thus, the complex according to the invention can integrate various types of reinforcing layer, whether woven, uni- or multidirectional textiles, or even textile reinforcements including several superimposed fibre layers, and for example superimpositions of laps of yarns oriented in different directions, of the “cross-ply” type. Mention can also be made of the textile reinforcements including a central layer performing a drainage function, acting as a spacer between two reinforcing layers, in order to permit the resin to flow during the injection or infusion process. Combinations of various reinforcing layers can also be employed, in association with the characteristic fixing layer.

In practice, the characteristic fixing layer can be prepared in various ways, according to the application and the type of textile reinforcement which it accompanies.

In a particularly advantageous embodiment, this fixing layer may consist of a thermoplastic film, compatible on the one hand with the textile reinforcement in terms of adhesion, and compatible on the other with the resin that is employed in the injection process.

Such a film has the advantage of having a surface that comes into contact with the textile reinforcement via many points which are defined at the time of the placement of the reinforcement in its final configuration.

Advantageously, this film can be stitched with the textile reinforcing layer, or at least, with part of the reinforcing layer when the latter comprises a plurality of superimposed layers. The points of passage of the stitching yarn constitute opening zones of the film when the latter has been heated to be joined to the reinforcement. In other words, the passage holes of the stitching yarn constitute openings allowing the passage of the resin during the injection process. Thus the characteristic film only marginally hinders the passage of the resin during the injection or infusion process.

The fixing layer may also be prepared of a grid itself composed of thermoplastic yarns, or a sticky film with an adhesive compatible with the textile reinforcement, and with the resin that will impregnate the said reinforcement.

In practice, the fixing layer may be combined with the textile reinforcing layer by a stitching or partial bonding operation, in order to form a complex that can be subsequently used to manufacture preformed reinforcements. The fixing layer may also be associated with a textile reinforcing layer at the actual time of production of the preform.

In this case, the procedure first consists in placing one or more textile fibre-based reinforcing layers in a preform mould. Then, the fixing layer is placed above the textile reinforcing layer or layers. The fixing layer, maintained in the preform mould, is then exposed to a heat source, in order to cause it to melt partially and be joined to the textile reinforcing layer.

Subsequently, when the fixing layer has cooled, it is joined at many points to the textile reinforcing layer, so that it maintains the latter in its configuration bent to the shape of the mould.

Various holding means can be employed to guarantee good contact between the fixing layer and the fibrous reinforcing layer. Among the means yielding good results, mention can be made of suction systems, which apply suction from the preform mould through the reinforcing layer, so that the fixing layer is pressed against the reinforcing layer before exposure to the heat source.

The characteristic fixing layer can be employed complementarily, to ensure the joining of the precut zones of the textile reinforcing layer. In other words, the fixing layer serves to join various widths of the reinforcement which face one another after folding inside the preform mould.

In the case of the use of an adhesive fixing layer, it can be placed cold, by bonding to the required locations.

The fixing layer may also serve to immobilise complementary members, such as foam or other inserts, inside the preform.

### BRIEF DESCRIPTION OF THE FIGURES

The manner of implementing the invention, and the advantages thereof, clearly appear from the description of the embodiments that follow, in conjunction with the appended figures in which:

FIG. 1 is a brief perspective view of a complex according to the invention, integrating a woven textile reinforcement.

FIG. 2 is a brief perspective view of an alternative embodiment of the complex, integrating a multilayer textile reinforcement.

FIG. 3 shows a cross section of a zone of the folded complex, after joining of the thermoplastic fixing layer.

FIGS. 4, 5 and 6 are brief perspective views of a preform mould illustrated with the progress of the preform production operations, first in the empty state, then in the state accommodating the textile reinforcement, and finally after placement of the fixing layer.

FIG. 7 is a brief perspective view of the preform obtained in the mould of FIG. 5, and turned over.

### MANNER OF IMPLEMENTING THE INVENTION

As already stated, the invention relates to a complex that can be used to manufacture a flexible preformed reinforcement, usable in resin injection or infusion moulding processes.

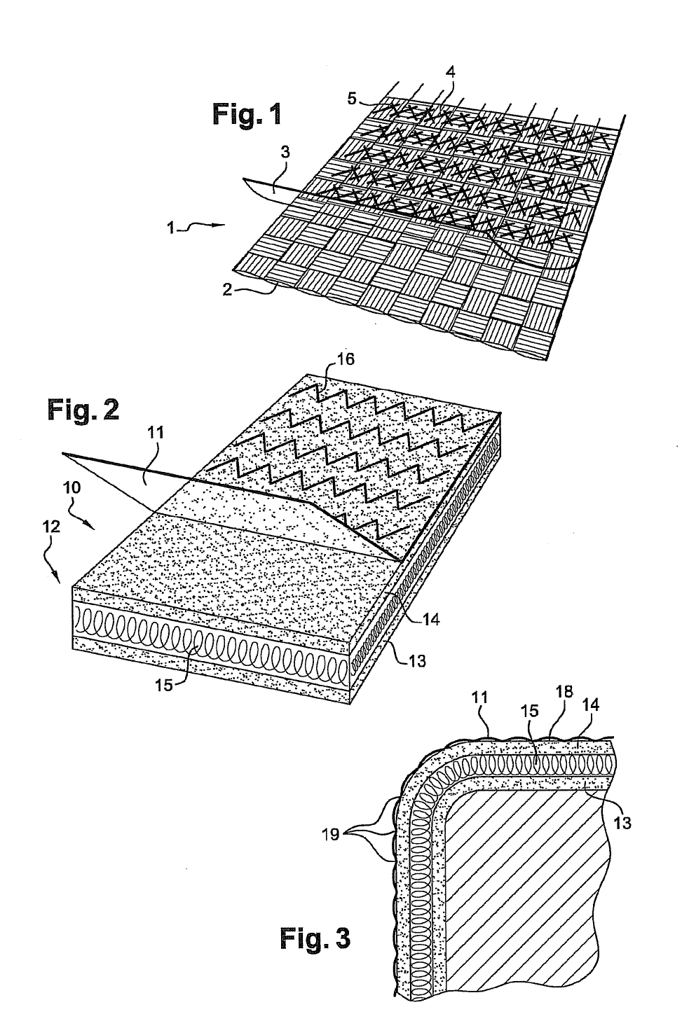

Various textile reinforcing layers can be used, such as for example a warp and weft woven textile, as shown in FIG. 1. More precisely, the textile reinforcing layer (2) constitutes a two-directional reinforcement insofar as the yarns used in the weft and warp are substantially balanced. It may involve for example a textile of glass, carbon, aramide or any other reinforcing fibre compatible with the injection or infusion processes. Unidirectional or multidirectional reinforcements can also be considered. This textile reinforcing layer (2) is combined with a fixing layer (3) formed by a film having an almost zero cold elongation, that is an inability to be stretched, at least under the normal mechanical stresses observed during operations of manual placement of the film in a preformed mould. This thermoplastic film (3) has a relatively low melting point, typically about 60 to 80° C., allowing its exposure to heat when associated with the textile reinforcing layer, and without degrading the properties thereof.

The fixing layer (3) is joined in the example in FIG. 1 to the textile reinforcing layer (2) by a stitch (4) which forms various holes (5) allowing the future passage of the resin during the injection process.

In certain cases, the thermoplastic film (3) may integrate pre-prepared perforations, increasing the passage flow area of the resin. If a larger passage area is desired, the film (3) can be replaced by a network of yarns deposited in liquid form on the textile reinforcing layer (2), or even by the grid structure including thermoplastic yarns, of the same type as the film mentioned above.

In an alternative embodiment shown in FIG. 2, the textile reinforcing layer (12) may be of many types, and may integrate several superimposed elementary layers. Thus, this textile reinforcing layer (12) may integrate two elementary reinforcing layers (13, 14), comprising reinforcing fibres, separated by a drainage layer (15) allowing the flow of the resin. By way of example, such a reinforcement may consist of a product sold under the trade name Rovicore® by the Applicant, and combining two layers consisting of a mat of cut glass fibres, separated by a non-woven layer based on texturised polypropylene to have a thickness and a spring effect. Many variants of this type of textile reinforcing layer can be employed, using a single mat of glass fibres, or even one or a plurality of additional layers forming an appearance core or other.

In the embodiment shown in FIG. 2, the fixing layer (11) is joined to all the elementary textile reinforcing layers by a stitching operation (16). This stitching may be unaccompanied, and also ensure the joining of the various elementary layers (13-15) of the textile reinforcement (12) together. The stitching may also be carried out on part of the layers only, for example to ensure the joining of the layer of thermoplastic film (11) only with the elementary layer (14) of the reinforcement with which it is in contact.

When the thermoplastic film (11) is exposed to a heat source, as shown in FIG. 3, it enters into a state of partial fusion so that it adheres to the face (18) of the textile reinforcing layer (14) on which it is placed. After cooling, the thermoplastic film freezes the configuration of the textile reinforcing layer (14), so that the latter preserves the fold thus produced. In fact, the adhesion of the thermoplastic film occurs at many points (19) on the whole uniformly distributed. The non-extensible character of the thermoplastic used, when it is at ambient temperature, means that the shape of the reinforcement is thus preserved.

The complex according to the invention can be used in a preform mould, to produce preform parts by placement inside the mould, followed by exposure to a heat source during its maintenance in the mould.

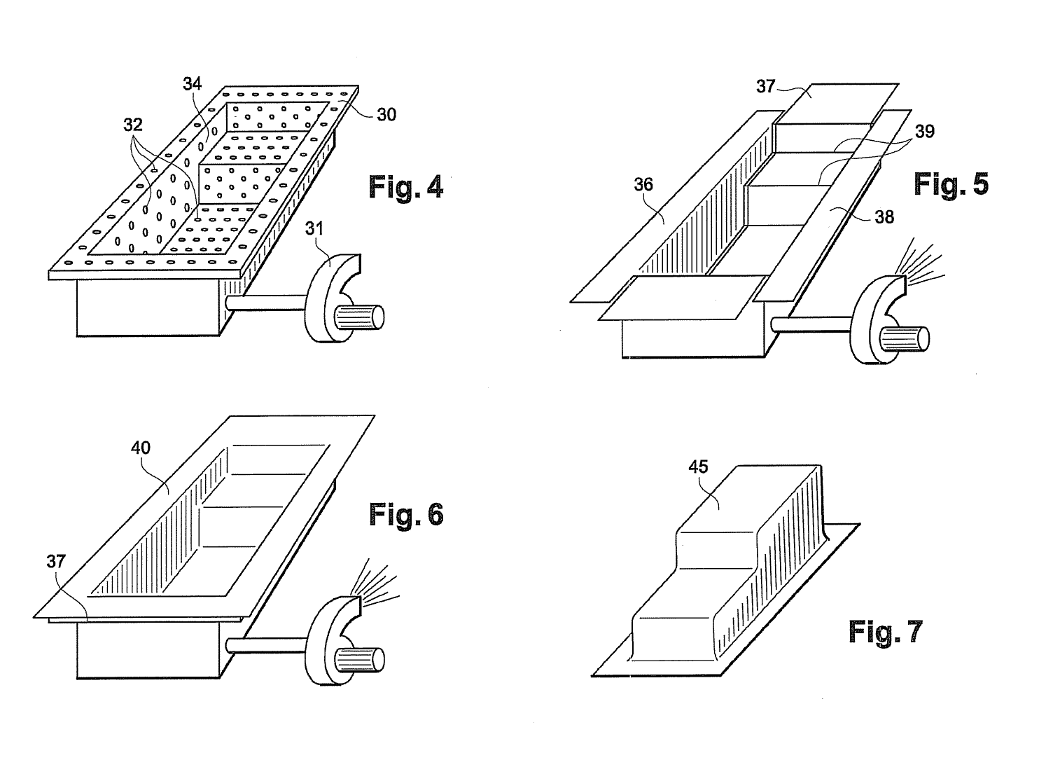

It is also possible, as shown in FIGS. 4 to 7, to join the film of the fixing layer to the textile reinforcement at the very moment of the preform reinforcement. Thus, as shown in FIG. 4, a preform mould (30) has a geometry corresponding to that of the part to be produced. Such a mould is associated with suction means (31), and comprises a plurality of holes (32) to ensure suction towards the walls (34) of the mould.

In a first step, the textile reinforcement (36-38), regardless of its type, is cut out to drape the inside walls (34) of the preform mould Various cutouts can be made, optionally with superimpositions of the textile reinforcing layer. Certain zones (39) of the textile reinforcing layer are thereby bent either with outwardly or inwardly oriented angles. A suction is then created in order to pull the textile reinforcing layer (36-38) against the walls (34) of the mould.

In a subsequent step, shown in FIG. 6, the film (40) of the fixing layer is then placed above the textile reinforcement (36-38). This film (40) is pressed against the textile reinforcement layer, because it is attracted by the suction means. The thermoplastic film (40) can be placed in a single piece in the case of small-volume parts, or in several strips or pieces when the shape of the preform to be obtained is more complex. It is possible to cover the entire surface of the textile layer, or even only certain zones which require preservation of a shape memory.

In certain alternative embodiments not shown, additional pieces, such as foam or other inserts can be added, and kept in place by using additional particular portions of thermoplastic film.

When the thermoplastic film is correctly placed on the textile reinforcing layer, this film (40) is melted by a heating system adapted to the geometry of the part, the type of film and the type of reinforcement. For example, in the case of a reinforcement integrating a polypropylene-based drainage core, the heating is moderate to avoid degrading the core of the reinforcement. The suction applied to press the film is also useful at the time of heating thereof, because it enables the material of the melting film to penetrate into the reinforcement fibres. Once the heating is stopped, this suction participates in the cooling of the film material.

At the end of the process, the preform reinforcement (45) can be removed from the preform mould, to yield a directly usable part, as shown in FIG. 7.

It appears from the above that the method according to the invention and the associated complex serve to produce preformed reinforcements having a capacity to be bent while preserving a shape memory, thereby considerably facilitating the storage and transport operations. The manufacturing process of the composite parts is therefore also improved, because it allows the use of preforms that are ready for use. It also has the substantial advantage of preserving the initial properties of the reinforcement, despite the preforming operation. It is also “clean” for the environment and the operators, because it does not require the spraying of resin or polluting product. A preform thus produced, thanks to its flexibility, can easily be placed in the mould, by comparison with the rigid preforms, without damaging the layers already present in the mould, and particularly the outer “gel coat” layers.

1. Textile complex (1) intended to be used as reinforcing layer for the manufacture of three-dimensional composite parts by resin injection or infusion processes, comprising at least one fibre-based reinforcing layer (2), characterized in that it comprises on one of its faces, a fixing layer (3) based on a thermoplastic having an almost zero cold elongation and a melting point below the melting point of the other materials of the complex, and in that the said fixing layer (3) is apertured to allow the passage of the injected or infused resin.

2. Textile complex according to claim 1, characterized in that it comprises a woven textile-based reinforcing layer (2).

3. Textile complex according to claim 1, characterized in that it comprises a reinforcing layer based on several superimposed laps of yarns oriented in different directions.

4. Textile complex (10) according to claim 1, characterized in that it comprises a series of several superimposed fibrous layers (13-15) whereof at least one of the central layers is a drainage layer (14).

5. Textile complex according to claim 1, characterized in that the fixing layer (3, 11) is formed by a thermoplastic film.

6. Textile complex according to claim 5, characterized in that the film (3, 11) is stitched (16) to the fibrous reinforcing layer.

7. Textile complex according to claim 1, characterized in that the fixing layer is formed by a grid composed of thermoplastic yarns.

8. Method for manufacturing a textile reinforcement for the production of three-dimensional composite parts, by a resin injection or infusion process, in which the reinforcement is preformed to the shape of the composite part before injection or infusion, characterized in that it comprises the following steps:
placement in a preformed mould (30) of at least one textile fibre-based reinforcing layer (36-38);
placement of a thermoplastic fixing layer (40) on the textile fibre-based reinforcing layer (36-38);
exposure of the thermoplastic fixing layer (40) maintained in the preformed mould (30) to a heat source, in order to cause the partial melting of the fixing layer (30) and its joining to the textile fibre-based reinforcing layer (36-38).

9. Method according to claim 8, characterized in that the fixing layer is maintained in the preformed mould by the application of suction (31) through the textile reinforcing layer (36-38), in order to press the fixing layer (40) against the said reinforcing layer.

10. Method according to claim 8, characterized in that portions of the fixing layer (40) are installed in the zones of the fibrous reinforcing layer which have cutouts.
